(19) United States
(12) Patent Application Publication
(10) Pub. No.: US 2007/0290980 A1
(43) Pub. Date: Dec. 20, 2007

(54) DIGITAL-TO-ANALOG CONVERSION UNIT, DRIVING APPARATUS AND PANEL DISPLAY APPARATUS USING THE SAME

(75) Inventors: Feng-Shou Lin, Taoyuan (TW); Yu-Yuan Chang, Taoyuan (TW); Kuo-Liang Shen, Taoyuan (TW); Wen-Fa Hsu, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: QUANTA DISPLAY INC., Taoyuan (TW)

(21) Appl. No.: 11/559,911

(22) Filed: Nov. 15, 2006

(30) Foreign Application Priority Data
Jun. 19, 2006 (TW) 95121869

(51) Int. Cl. G09G 3/36

(52) U.S. Cl. 345/100

(57) ABSTRACT

A digital-to-analog conversion unit, and a driving apparatus and a panel display apparatus using the same are provided. A driving voltage output from the digital-to-analog conversion unit can be a positive polarity voltage or a negative polarity voltage, wherein the driving voltage output from an output buffer is a positive polarity voltage and the driving voltage output from an output inverter is a negative polarity voltage. The apparatus only needs one set of grayscale voltage so that the layout area of the apparatus, and the flicker and the residual images of the display panel can be reduced.

### CROSS-REFERENCE TO RELATED APPLICATION

This application claims the priority benefit of Taiwan application serial no. 95121869, filed Jun. 19, 2006. All disclosure of the Taiwan application is incorporated herein by reference.

### BACKGROUND OF THE INVENTION

1. Field of Invention

The present invention relates to a driving apparatus for a display panel. More particularly, the present invention relates to a panel driving apparatus using a negative voltage.

2. Description of Related Art

In order to avoid a residual image phenomenon caused by liquid crystal polarization, the voltage polarity of the driving voltage for driving the liquid crystal display (LCD) panel must be periodically converted, so as to facilitate the inversion effect of the liquid crystal. The inversion driving method for the LCD panel comprises, for example, line inversion, column inversion, dot inversion, and the like. FIG. 1 is a schematic view of a common driving method of dot inversion. The dot inversion utilizes that in one frame period, no matter in the horizontal or vertical direction, the adjacent sub-pixels have opposite polarities, and in the next frame period, the polarity of the same sub-pixel is inverted.

As known from the above, the driving apparatus for the LCD panel must have two driving voltages with different voltage polarities directed to the same grayscale display. As shown in FIG. 2, the conventional LCD panel employs a design of common voltage Vcom, such that the driving voltages are classified into positive polarity voltages (e.g., 14 V) higher than the Vcom, and negative polarity voltages (e.g., 0 V) lower than the Vcom. However, when the conventional driving apparatus is implemented, the digital-to-analog conversion unit in the source driver must have the capability of outputting two sets of voltages with different polarities.

For example, as shown in FIG. 3, a source driver of a conventional 8-bit display panel comprises a grayscale voltage generator 301, a data latch unit 302, a conventional digital-to-analog conversion unit 303, and a switch device 304. The grayscale voltage generator 301 outputs a grayscale voltage to the digital-to-analog conversion unit 303. The data latch unit 302 outputs an 8-bit digital data to the conventional digital-to-analog conversion unit 303 according to a latching result. Then, the conventional digital-to-analog conversion unit 303 converts the 8-bit digital data into a corresponding driving voltage. Thereafter, the output channel (Ch₁-Ch_{2N}) is switched by the switch device 304, so as to provide the driving voltage to the sub-pixel to be driven.

As shown in FIG. 4, it is a block diagram of the grayscale voltage generator 301, the conventional digital-to-analog conversion unit 303, and the switch device 304. The conventional digital-to-analog conversion unit 303 comprises 2N digital-to-analog converters DAC₁-DAC_{2N} and 2N output buffers BF₁-BF_{2N}. The switch device 304 comprises 2N switches SW₁-SW_{2N}. The odd-numbered digital-to-analog converters (DAC1, DAC3, DAC5 . . . ) and the subsequently coupled odd-numbered output buffers (BF1, BF3, BF5 . . . ) are used to generate a positive polarity voltage. The even-numbered digital-to-analog converters (DAC2, DAC4, DAC6 . . . ) and the subsequently coupled even-numbered output buffers (BF2, BF4, BF6 . . . ) are used to generate a negative polarity voltage. When the output channels Ch₁-Ch_{2N} of the digital-to-analog conversion unit 303 are switched by the switch device 304, both positive/negative polarity voltages are generated through one output channel.

FIG. 5 shows the architecture of the grayscale voltage generator 301 for providing the grayscale voltage to the digital-to-analog converter DAC₁-DAC_{2N}. The grayscale voltage generator 301 generates positive grayscale voltages V_{G0+}-V_{G255+} by utilizing the received analog voltages V_{A1}-V_{A8}. The other set of negative grayscale voltages V_{G0-}-V_{G255-} is formed by the analog voltages V_{A9}-V_{A16} together with voltage-divider resistors R₂₅₆-R₅₁₀. As known from the above, as for a source driver, the voltage-divider resistors R1-R510 in the grayscale voltage generator 301 occupy a large space in the circuit layout.

In addition, as shown in FIG. 6, the 16 analog voltages V_{A1}-V_{A16} received by the source driver in FIG. 3 are generated by the analog voltage generator 601 and then output to each of the source drivers 602-604 through the analog voltage wiring. FIG. 7 is a detailed circuit diagram of an analog voltage generator 601. The analog voltages V_{A1}-V_{A16} are generated by the voltage-divider resistors R₇₀₁-R₇₃₂ by the use of resistance voltage-divider. Therefore, the required large amount of grayscale voltages results in not only a large number of voltage-divider resistors R₁-R₅₁₀ in the source driver, but also a large number of analog voltage wirings outside the source driver and a large number of voltage-divider resistors R₇₀₁-R₇₃₂ in the analog voltage generator 601, which is a trouble in the design of the panel driving apparatus.

The architecture of the conventional source driver also utilizes the analog voltage V_{A1}-V_{A16} to generate the positive/negative grayscale voltages (V_{G0+}-V_{G255+} and V_{G0-}-V_{G255-}), and thus the phenomena of flicker and residual images occur on the LCD panel correspondingly. As shown in FIG. 8, the analog voltages V_{A1}-V_{A8} are positive analog voltages with respect to the common voltage Vcom. The other set of analog voltages V_{A9}-V_{A18} are negative analog voltages with respect to the common voltage Vcom. In FIG. 8, the solid line indicates the voltage level of the analog voltages V_{A1}-V_{A16} with respect to the common voltage Vcom under the normal condition. When the analog voltages V_{A9}, V_{A10}, V_{A12}, and V_{A13} are offset (indicated by the dashed line in FIG. 8), the voltage difference between the analog voltage V_{A8} and the common voltage Vcom is larger than the voltage difference between the analog voltage V_{A9} and the common voltage Vcom. The circumstance of the analog voltage V_{A7} and the corresponding analog voltage V_{A10} is similar to the above, and also the circumstance of the analog voltages V_{A5} and V_{A12}, and the analog voltages V_{A4} and V_{A13} is similar to the above. As such, the display panel depending on the common voltage Vcom may have the problem of flicker due to different offset angles of the same grayscale display caused by the offset of analog voltages when the liquid crystal is inversed. Besides, when the offset occurs, the analog voltages V_{A1} and V_{A16} indicating the dim frame may make the liquid crystal not have an inversion mechanism, thus causing the liquid crystal polarization, thereby the residual images exist in the frame.

### SUMMARY OF THE INVENTION

An objective of the present invention is to provide a driving apparatus for a display panel, wherein an output inverter is used as a mechanism for inversing the voltage polarity, so as to reduce the occupation of the circuit layout area, thereby reducing the manufacturing cost.

Another objective of the present invention is to provide a digital-to-analog conversion unit, so as to significantly reduce the required grayscale voltage wirings, thereby saving the circuit layout area and the manufacturing cost.

In order to achieve the above and other objectives, the present invention provides a driving apparatus of a display panel, which comprises a data latch unit, a grayscale voltage generator, a digital-to-analog conversion unit, and a switch device. The digital-to-analog conversion unit at least comprises a first digital-to-analog converter, a second digital-to-analog converter, an output buffer, and an output inverter. The data latch unit outputs multiple M-bit digital data to the digital-to-analog conversion unit. The grayscale voltage generator generates 2^{M} grayscale voltages with the same voltage polarity. The digital-to-analog conversion unit converts the input M-bit digital data to the corresponding driving voltages. The voltage polarities of the driving voltages are classified into positive polarity voltages output by the output buffer and negative polarity voltages output by the output inverter. The positive/negative polarity voltage is determined depending on the common voltage, and the common voltage of the present invention is a ground level. Then, the same output channel provides a positive polarity voltage or a negative polarity voltage by the switching of the switch device.

In an embodiment of the driving apparatus of a display panel, the switch device at least comprises a first switch and a second switch. The first switch and the second switch are three-terminal switches, wherein a first terminal and a second terminal of the first switch are respectively coupled to the output buffer and the output inverter, and a first terminal and a second terminal of the second switch are respectively coupled to the output inverter and the output buffer. In the first time period, the first terminal and the third terminal of the first switch and the second switch are respectively conducted. In the second time period, the second terminal and the third terminal of the first switch and the second switch are respectively conducted. Thus, the third terminals of the first switch and the second switch are used to provide a positive polarity voltage output by the output buffer, or a negative polarity voltage output by the output inverter.

In an embodiment of the driving apparatus of a display panel, the output inverter comprises a first resistor, a second resistor, a first amplifier, and a second amplifier. The first resistor, the second resistor, and the first amplifier form an inverting amplifier architecture, and the voltage output by the output inverter is made to be a negative polarity voltage. The first input terminal of the second amplifier coupled subsequently to the first amplifier is electrically connected to the output of the second amplifier, so as to form a buffer stage with a single gain, thereby enhancing the driving ability of the output inverter.

In another embodiment of the driving apparatus of a display panel, the output inverter comprises a third resistor, a fourth resistor, a fifth resistor, a sixth resistor, a variable resistor, a third amplifier, and a fourth amplifier. The third resistor, the fourth resistor, and the third amplifier form an inverting amplifier architecture, and through voltage-divider formed by the fifth resistor, the sixth resistor, and the variable resistor, the second input terminal of the third amplifier is biased at the node voltage. Thus, by fine tuning the node voltage, the output inverter adjusts the panel, and thus the voltage bias is caused by a feed-through effect. The first input terminal of the fourth amplifier coupled subsequently to the third amplifier is electrically connected to the output of the fourth amplifier, so as to form a buffer stage with a single gain, thereby enhancing the driving ability of the output inverter.

In another aspect, the present invention further provides a digital-to-analog conversion unit, which comprises 2N digital-to-analog converters, N output buffers, and N output inverters, wherein N is an integer larger than 0, i.e., a positive integer. The (i)^{th} output buffer is coupled to the (2i−1)^{th} digital-to-analog converter, and the (i)^{th} output inverter is coupled to the (2i)^{th} digital-to-analog converter, wherein i is an integer and 1≦i≦N. Each output buffer outputs a positive polarity voltage, and each corresponding output inverter outputs a negative polarity voltage, wherein the positive/negative polarity voltage is determined depending on the common voltage, and the common voltage of the present invention is a ground level.

In addition, the present invention further provides a panel display apparatus, which comprises a display panel, a gate driving circuit, and a driving apparatus. The gate driving circuit is used to output at least one scan signal, and thus the driving apparatus provides at least a first driving voltage and a second driving voltage respectively through the output channel in accordance with the scan signal. In the process of the driving apparatus generating the first driving voltage and the second driving voltage, the grayscale voltage generator is used to generate multiple grayscale voltages with the same voltage polarity, and then the digital-to-analog conversion unit determines whether or not to inverse the grayscale voltage according to the received digital data, thereby at least providing the first driving voltage and the second driving voltage. Then, the switch device is used to switch the first driving voltage and the second driving voltage to the path of the output channel, so as to allow the output channel to provide the first driving voltage in a frame period, and provide the second driving voltage in the next frame period.

According to the preferred embodiments of the present invention, in the driving apparatus of the display panel, the output inverter is used as a main mechanism for converting the voltage polarity, such that the driving voltage output by the digital-to-analog conversion unit is classified into a positive polarity voltage or a negative polarity voltage. Therefore, when the grayscale voltages supplied to the digital-to-analog conversion unit are reduced, the layout area of the driving apparatus of a display panel is effectively reduced. The phenomena of the flicker and residual images of the display panel are also reduced.

In order to make the aforementioned and other objects, features and advantages of the present invention comprehensible, preferred embodiments thereof accompanied with figures are described in detail below.

### BRIEF DESCRIPTION OF THE DRAWINGS

FIG. 1 is a schematic view of a conventional dot inversion driving method.

FIG. 2 is a timing diagram for a driving voltage of a conventional source driver.

FIG. 3 is a block diagram of a main structure for a conventional source driver.

FIG. 4 is a block diagram of the internal details of the conventional source driver in FIG. 3.

FIG. 5 is a detailed circuit diagram of a conventional grayscale voltage generator.

FIG. 6 is a schematic view of an analog voltage wiring to each source driver.

FIG. 7 is a detailed circuit diagram of a conventional analog voltage generator.

FIG. 8 is a voltage level diagram for an analog voltage of a conventional source driver with respect to the common voltage.

FIG. 9 is a timing diagram of a driving voltage according to an embodiment of the present invention.

FIG. 10 is a block diagram of a main structure of a driving apparatus according to a preferred embodiment of the present invention.

FIG. 11 is a block diagram of the internal details of the driving apparatus in FIG. 10.

FIGS. 12A and 12B are the detailed circuit diagram of a reference voltage generator and an analog voltage generator according to a preferred embodiment of the present invention.

FIG. 13 is a voltage level diagram for an analog voltage and a driving voltage with respect to the common voltage according to a preferred embodiment of the present invention.

FIG. 14 is a detailed circuit diagram of an output inverter according to a preferred embodiment of the present invention.

FIG. 15 is a detailed circuit diagram of another output inverter according to a preferred embodiment of the present invention.

FIG. 16 is a panel display apparatus according to an embodiment of the present invention.

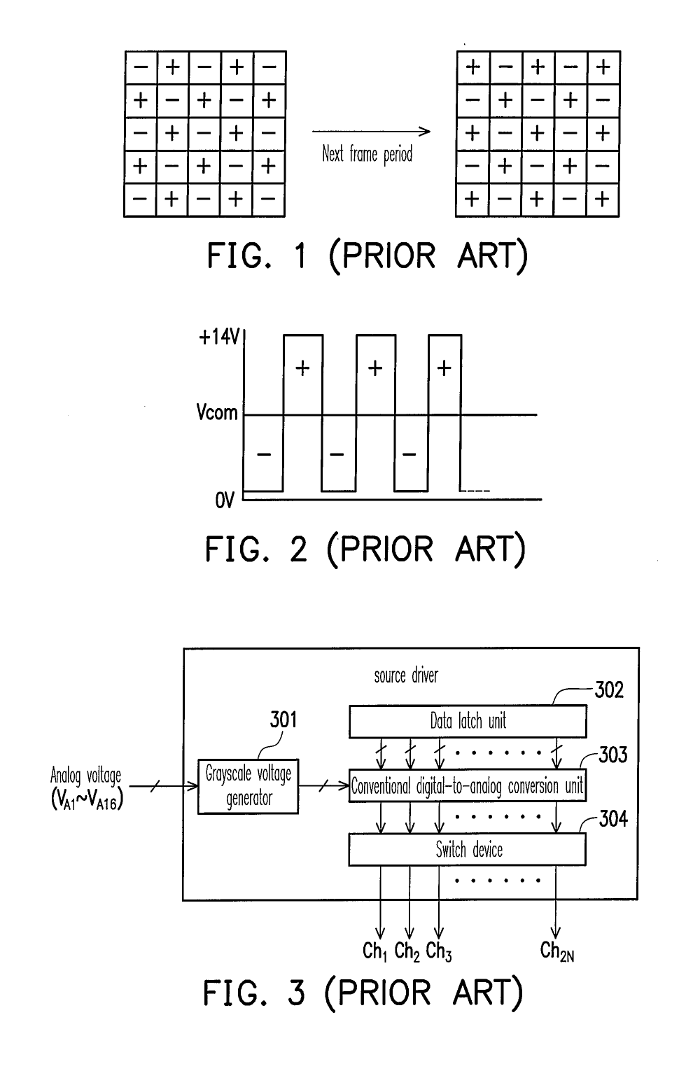

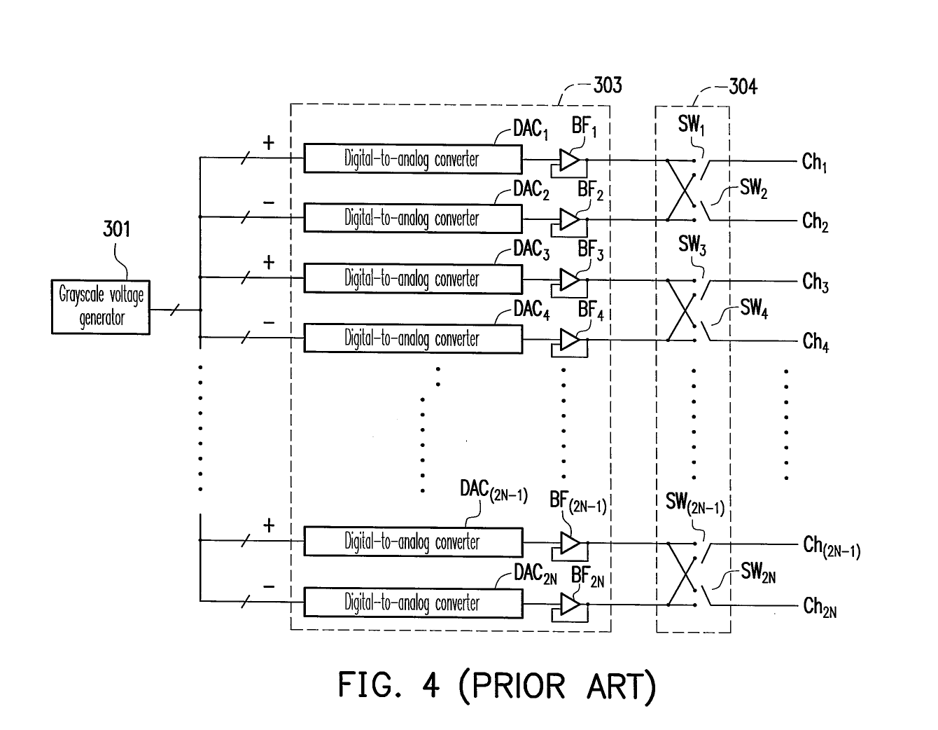

### DESCRIPTION OF EMBODIMENTS

FIG. 9 is a timing diagram of a driving voltage according to an embodiment of the present invention. In order to facilitate the inversion effect of the liquid crystal, in the present embodiment, a common voltage Vcom is a ground level used to divide the voltage polarities of driving voltages. As shown in FIG. 9, when the driving voltage is higher than the common voltage Vcom, it is a positive polarity voltage (e.g., 7 V). On the contrary, when the driving voltage is lower than the common voltage Vcom, it is a negative polarity voltage (e.g., −7 V). The positive polarity voltage is also a positive voltage, and the negative polarity voltage is a negative voltage. Therefore, from another point of view, the driving voltage of the display panel is achieved in the present embodiment in a manner of a negative polarity voltage (negative voltage).

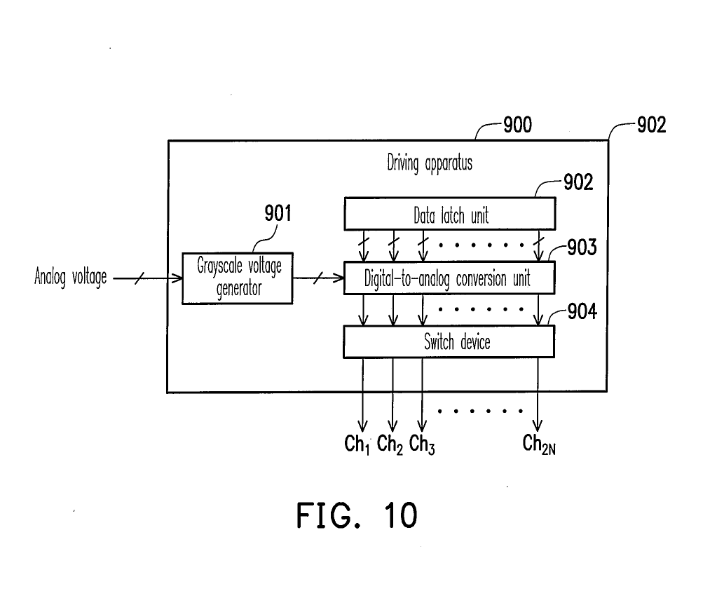

FIG. 10 is a block diagram of a main structure of a driving apparatus 900 of a display panel according to an embodiment of the present invention. Referring to FIG. 10, the driving apparatus 900 comprises a grayscale voltage generator 901, a data latch unit 902, a digital-to-analog conversion unit 903, and a switch device 904. The digital-to-analog conversion unit 903 is coupled to the data latch unit 902 and the grayscale voltage generator 901, and the switch device 904 is coupled to the digital-to-analog conversion unit 903. The data latch unit 902 outputs multiple M-bit digital data according to a latch result, and the grayscale voltage generator 901 generates 2^{M} grayscale voltages. The digital-to-analog conversion unit 903 converts the input M-bit digital data to corresponding driving voltages. Then, the driving voltages are switched to the desirable output channels Ch₁-Ch_{2N} by the switch device 904, wherein M is a positive integer.

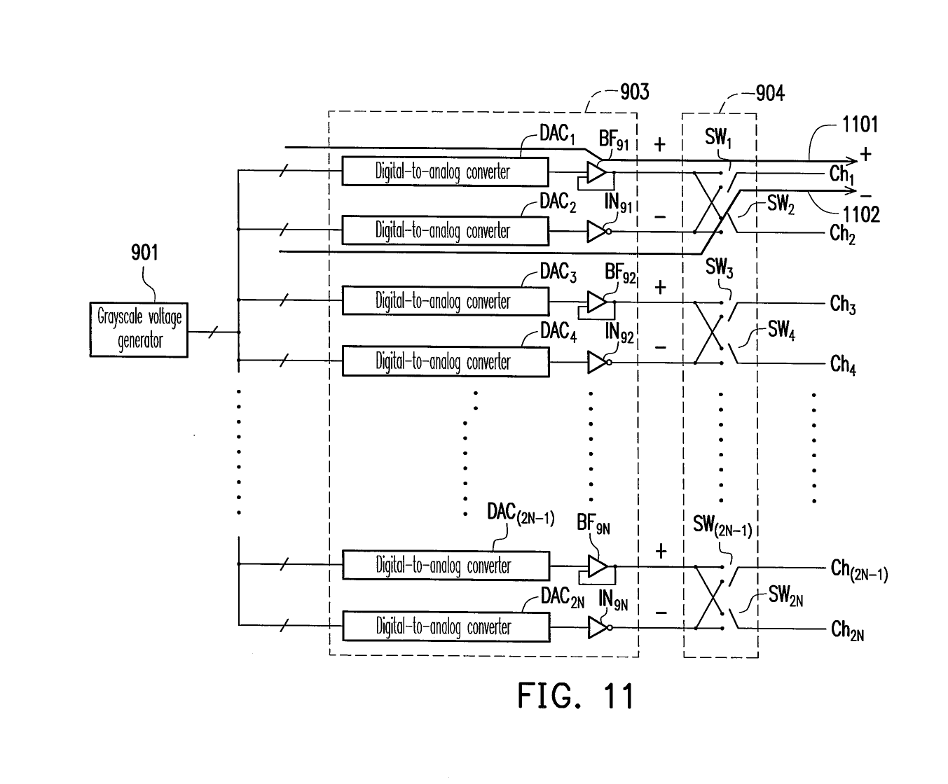

Referring to FIG. 11, it is a detailed block diagram of the grayscale voltage generator 901, the digital-to-analog conversion unit 903, and the switch device 904. The digital-to-analog conversion unit 903 comprises 2N digital-to-analog converters DAC₁-DAC_{2N}, N output buffers BF₉₁-BF_{9N}, and N output inverters IN₉₁-IN_{9N}. The switch device 304 comprises 2N switches SW₁-SW_{2N}, wherein N is a positive integer. The grayscale voltage generator 901 is coupled to the digital-to-analog converters DAC₁-DAC_{2N}. The (2j−1)^{th} digital-to-analog converter DAC₁-DAC_{2N} is coupled to the (i)^{th} output buffer BF₉₁-BF_{9N}, and the (2i)^{th} digital-to-analog converter DAC₁-DAC_{2N} is coupled to the (i)^{th} output inverter IN₉₁-IN_{9N}, wherein i is an integer and 1≦i≦N. In addition, a first terminal of the (2j−1)^{th} switch SW₁-SW_{2N} is coupled to the (j)^{th} output buffer BF₉₁-BF_{9N}, and a second terminal of the (2j−1)^{th} switch SW₁-SW_{2N} is coupled to the (j)^{th} output inverter IN₉₁-IN_{9N}. A first terminal of the (2j)^{th} switch SW₁-SW_{2N} is coupled to the (j)^{th} output inverter IN₉₁-IN_{9N}, and the second terminal of the (2j)^{th} switch SW₁-SW_{2N} is coupled to the (j)^{th} output buffer BF₉₁-BF_{9N}. A third terminal of each of the switches SW₁-SW_{2N} outputs a driving voltage, wherein j is an integer and 1≦j≦N.

The grayscale voltage generator 901 provides the 2^{M} grayscale voltage to each of the digital-to-analog converters DAC₁-DAC_{2N}. The digital-to-analog converters DAC₁-DAC_{2N} are used to convert the M-bit digital data into corresponding grayscale voltages. Then, the output buffers BF₉₁-BF_{9N} amplify the output of the digital-to-analog converters DAC₁-DAC_{2N}, and the output inverters IN₉₁-IN_{9N} are used to invert the voltage polarities of the voltages output by the digital-to-analog converters DAC₁-DAC_{2N}. In the embodiment, the output buffers BF₉₁-BF_{9N} are used to output a positive polarity voltage (positive voltage), and the output inverters IN₉₁-IN_{9N} are used to output a negative polarity voltage (negative voltage). Therefore, the same one of the output channels Ch₁-Ch_{2N} is switched by the switch device 904 for providing a positive polarity voltage or a negative polarity voltage.

For example, in a first time period, the odd-numbered output channels (Ch1, Ch3, . . . , Ch_{2N-1}) are required to output a positive polarity voltage, and the even-numbered output channels (Ch2, Ch4, . . . , Ch_{2N}) are required to output a negative polarity voltage. After being switched by the switch device 904, the odd-numbered output channels (Ch1, Ch3, . . . , Ch_{2N-1}) are coupled to the output of the output buffers BF₉₁-BF_{9N}, for example, indicated by the arrow 1101 in FIG. 11. The even-numbered output channels (Ch2, Ch4, . . . , Ch_{2N}) are coupled to the output of the output inverters IN₉₁-IN_{9N}. On the contrary, in a second time period, i.e., the next frame period, the polarities of the driving voltage in the same channel are required to be converted. At this time, after being switched by the switch device 904, the odd-numbered output channels (Ch1, Ch3, . . . , Ch_{2N-1}) are coupled to the output of the output inverters IN₉₁-IN_{9N}, for example, indicated by the arrow 1102 in FIG. 11. The even-numbered output channels (Ch2, Ch4, . . . , Ch_{2N}) are coupled to the output of the output buffers BF₉₁-BF_{9N}. Therefore, the digital-to-analog conversion unit 903 generates positive/negative polarity voltages from the same output channel by the switch device 904 switching the output thereof.

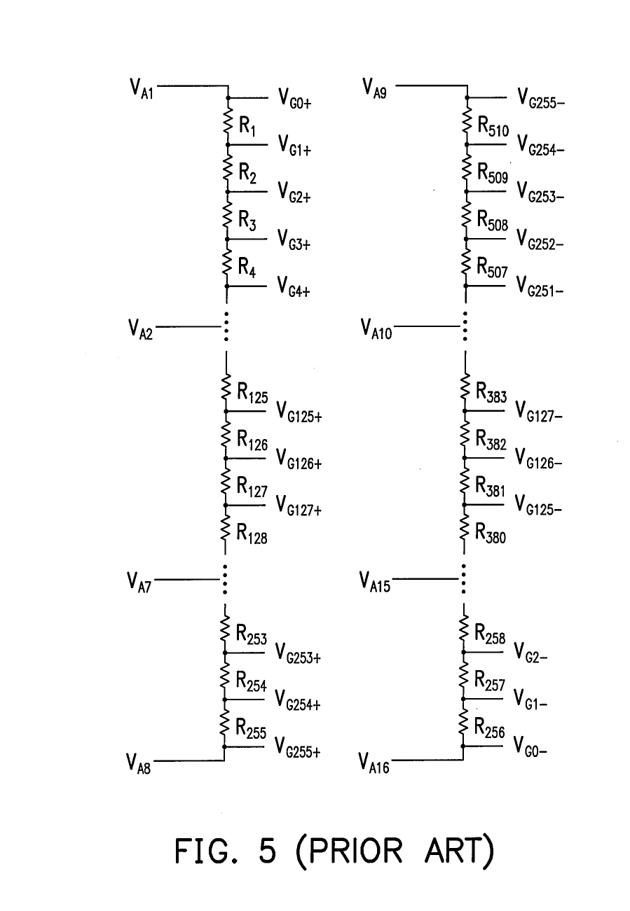

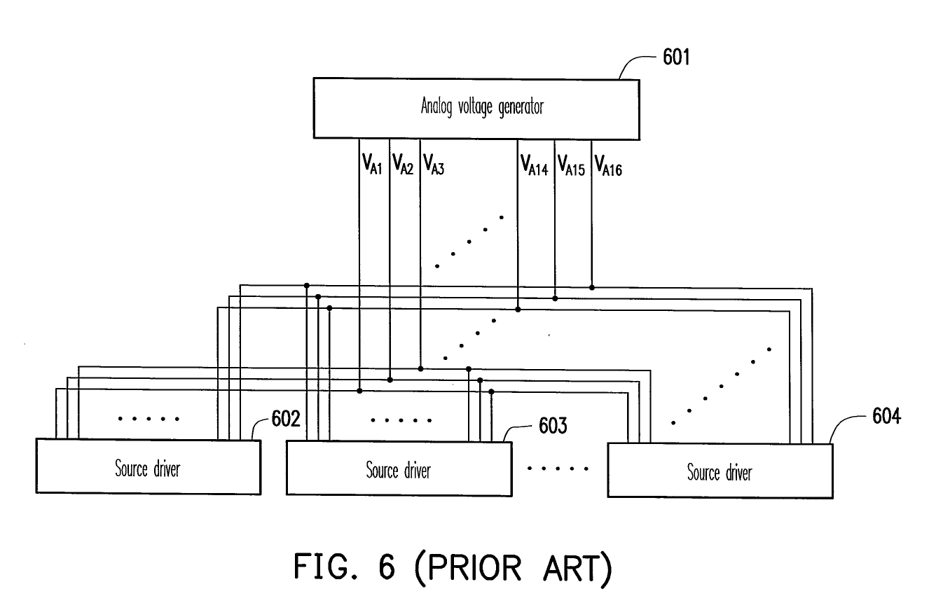

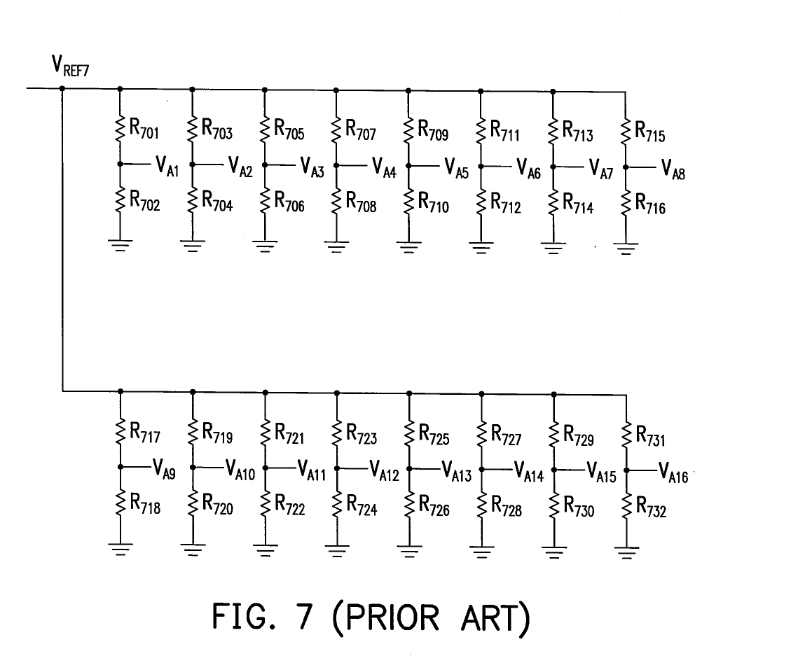

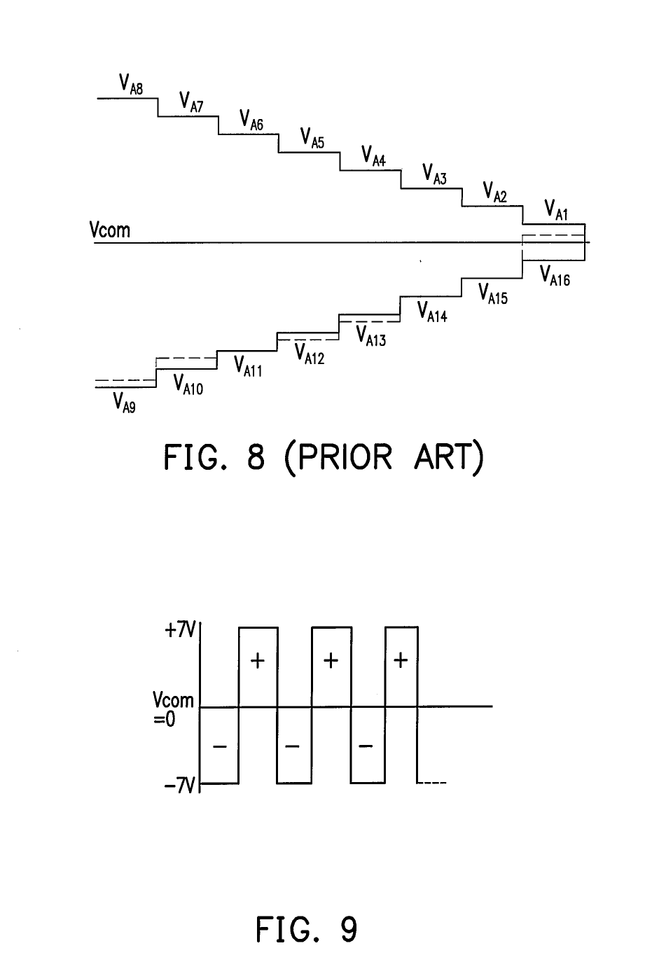

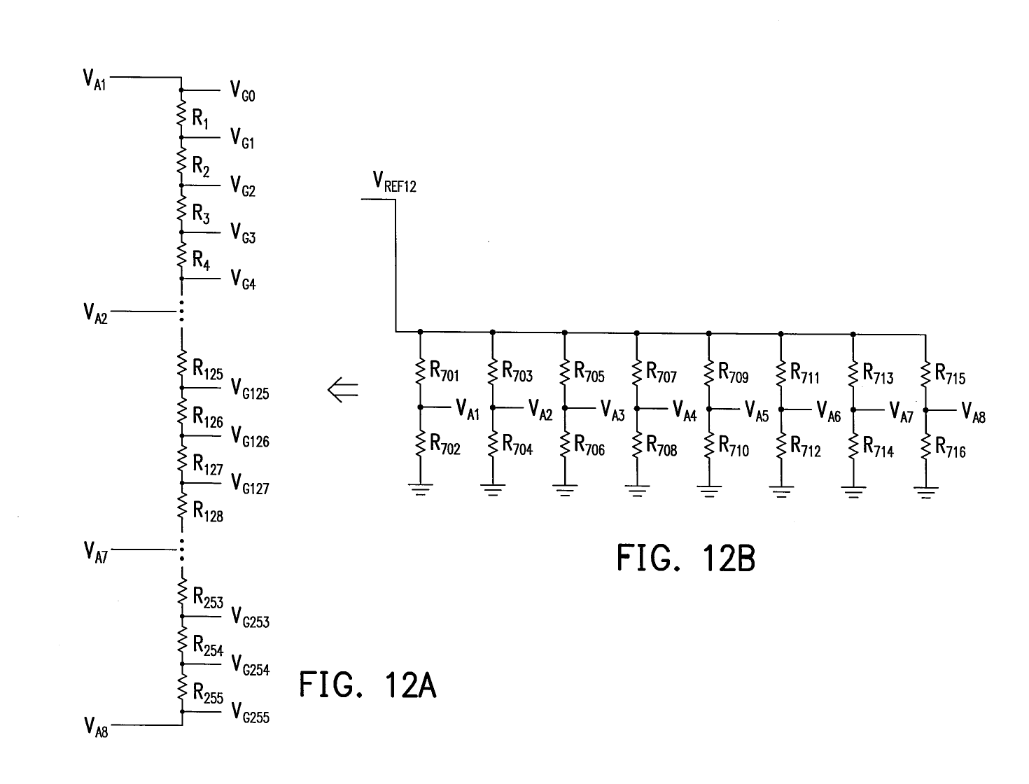

Compared with a conventional architecture, the grayscale voltage generator 901 only needs to generate one set of grayscale voltages, such that the circuit layout area is significantly reduced. For example, the grayscale voltage generator in a source driver of a conventional 8-bit display panel is required to generate the grayscale voltages with positive/negative polarities. Under this condition, as shown in FIGS. 5-7, the conventional grayscale voltage generator must generate two sets of grayscale voltages (V_{G0+}-V_{G255+} and V_{G0-}-V_{G255-}), and two sets of analog voltages (V_{A1}-V_{A8} and V_{A9}-V_{A16}) must be supplied to the grayscale voltage generator. Comparatively, the conventional source driver requires a large number of voltage-divider resistors R₁-R₅₁₀ therein, and a large number of analog voltage wirings connected to the external analog voltage generator 601. However, in the present embodiment, as shown in FIGS. 12A and 12B, the grayscale voltage generator in the source driver of the 8-bit display panel is required to generate only one set of grayscale voltages (V_{G0}-V_{B255}), and correspondingly is required to supply only one set of analog voltages (V_{A1}-V_{A8}) to the reference voltage generator 901. Therefore, in the circuit layout, not only the number of the voltage-divider resistors in the present embodiment is reduced, but also the consumption of the analog voltage wirings is also reduced.

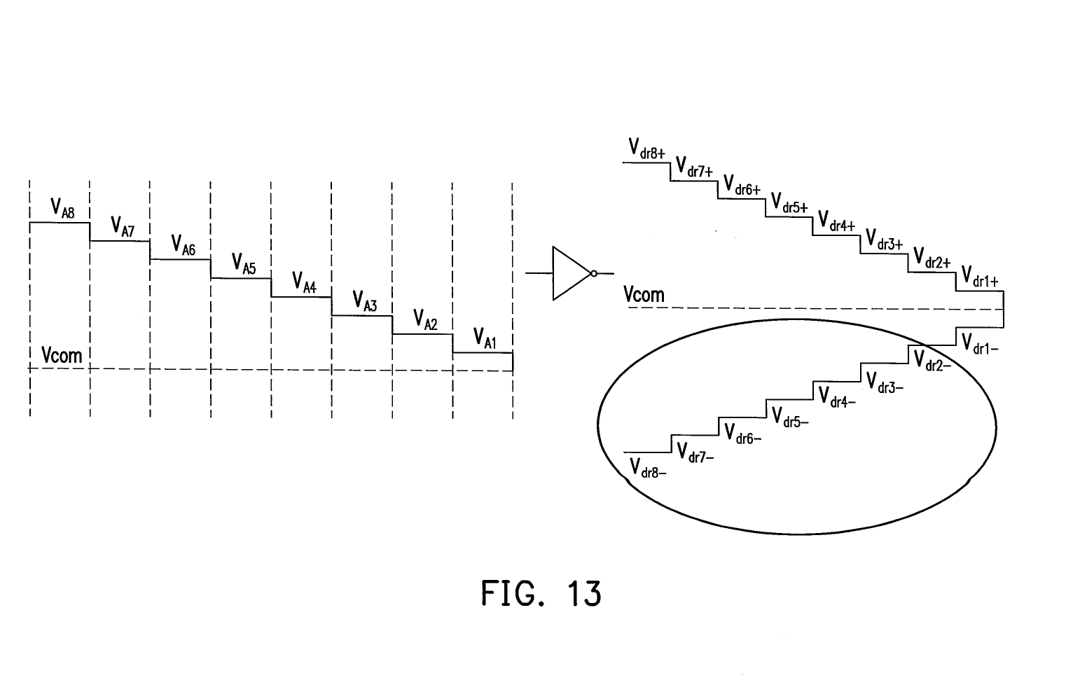

Besides, as shown in FIG. 13, only one set of analog voltages (V_{A21}-V_{A28}) is required to be supplied to the reference voltage generator 901 in the present embodiment. Therefore, the grayscale voltages obtained from the reference voltages (V_{A21}-V_{A28}), the negative polarity voltages (V_{dr1-}-V_{dr8-}) obtained from the output inverters, and positive polarity voltages (V_{dr1+}-V_{dr8+}) obtained from the output buffers are considered with respect to the common voltage Vcom. The voltage difference of the positive/negative polarity voltage (V_{dr1+} and V_{dr1-}, . . . , V_{dr8+} and V_{dr8-}) of the same grayscale display with respect to the common voltage Vcom is not similar to that of the conventional architecture, and the circumstance that the offset of the analog voltages (V_{A21}-V_{A28}) results in the phenomena of the flicker and residual images will not occur.

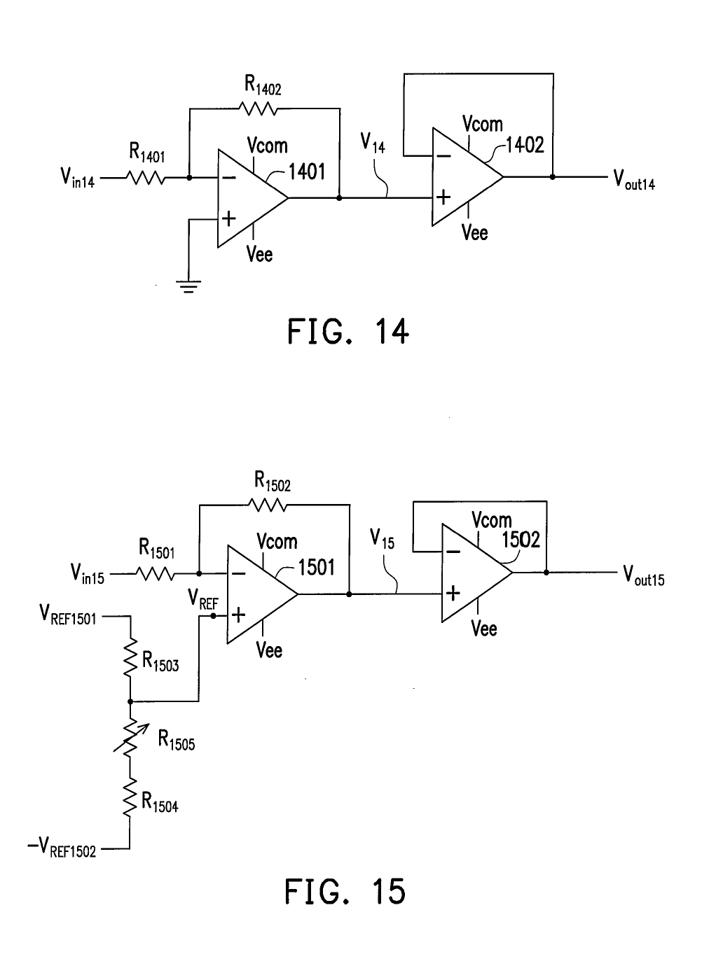

FIG. 14 is a detailed circuit diagram of an output inverter according to an embodiment of the present invention, which comprises amplifiers 1401 and 1402, and resistors R₁₄₀₁ and R₁₄₀₂. For the convenience of illustration, the node voltage V₁₄ is marked. A first terminal of the resistor R₁₄₀₁ receives an input voltage Vᵢₙ₁₄. A first input terminal of the amplifier 1401 is coupled to a second terminal of the resistor R₁₄₀₁ and a first terminal of the resistor R₁₄₀₂, and a second input terminal of the amplifier 1401 is coupled to the ground. A second terminal of the resistor R₁₄₀₂ is coupled to an output of the amplifier 1401. A second input terminal of the amplifier 1402 is coupled to the output of the amplifier 1401. A first input terminal of the amplifier 1402 is electrically connected to an output of the amplifier 1402. In the present embodiment, the output inverter is used to output a negative polarity voltage, i.e., the negative voltage. Therefore, the resistors R₁₄₀₁, R₁₄₀₂ and the amplifier 1401 form an inverting amplifier architecture in the present embodiment for generating a negative voltage, expressed by Equation (1):

$${V}_{14} = - \frac{{R}_{1402}}{{R}_{1401}} {V}_{in 14} = {V}_{out 14} . \qquad ( 1 )$$

At this time, the negative voltage, i.e., node voltage V₁₄, is output to the switch set 904 via the single gain buffer stage formed by the amplifier 1402, and thus the output voltage Vₒᵤₜ₁₄ is also expressed by Equation (1) which has a voltage polarity being opposite to that of the input voltage Vᵢₙ₁₄. The output inverter operates between the common voltage Vcom and the negative voltage Vee. Comparatively, the output buffer operates between the positive voltage and the common voltage Vcom. The absolute values of the positive voltage and the negative voltage Vee are equal.

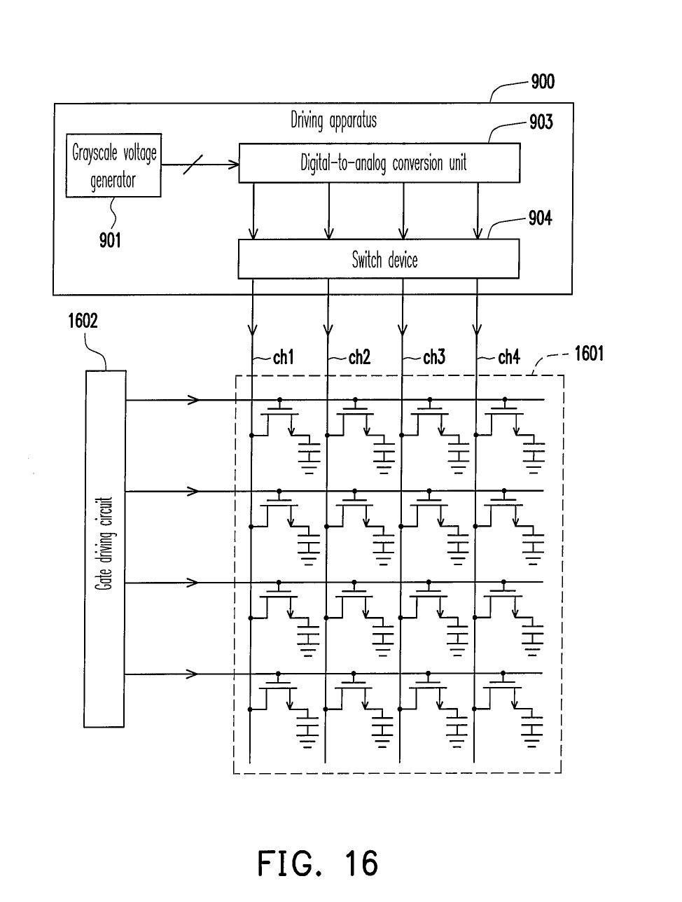

Another embodiment of the output inverter is illustrated as follows. As shown in FIG. 15, the output inverter comprises amplifiers 1501 and 1502, resistors R₁₅₅₁-R₁₅₀₄, and a variable resistor R₁₅₀₅. For the convenience of illustration, the node voltages V₁₅ and V_{REF} are marked herein. A first terminal of the resistor R₁₅₀₁ receives an input voltage Vᵢₙ₁₅. A first input terminal of the amplifier 1501 is coupled to a second terminal of the resistor R₁₅₀₁ and a first terminal of the resistor R₁₅₀₂, and a second input terminal of the amplifier 1501 is coupled to a second terminal of the resistor R₁₅₀₃. A first terminal of the variable resistor R₁₅₀₅ is coupled to the second terminal of the resistor R₁₅₀₃, and a second terminal of the variable resistor R₁₅₀₅ is coupled to a first terminal of the resistor R₁₅₀₄. The second terminal of the resistor R₁₅₀₂ is coupled to an output of the amplifier 1501. A second input terminal of the amplifier 1502 is coupled to the output of the amplifier 1501, and a first input terminal of the amplifier 1502 is electrically connected to an output of the amplifier 1502. The output inverter in the present embodiment is substantially the same as that of FIG. 14 in terms of the working principle and architecture. The amplifier 1501 and resistors R₁₅₀₁, R₁₅₀₂ form an inverting amplifier architecture in the present embodiment, so as to generate the node voltage V₁₅ with the polarity opposite to that of the input voltage Vᵢₙ₁₅, and then output the node voltages V₁₅ via the single gain buffer stage formed by the amplifier 1502. Compared with the above embodiment, the most significant difference lies in that the second input terminal of the amplifier 1501 for forming the inverting amplifier architecture is not coupled to the ground, but is biased at the node voltage V_{REF}. Therefore, the value of the node voltage V₁₅ is expressed by Equation (2), and besides being relevant to the resistors R₁₅₀₁, R₁₅₀₂, the node voltage V_{REF} is also one of the variable factors:

$${V}_{15} = - \frac{{R}_{1502}}{{R}_{1501}} ( {V}_{in 15} - {V}_{REF} ) + {V}_{REF} = {V}_{out 15} . \qquad ( 2 )$$

Herein, the voltage bias of the panel caused by the feed-through effect can be adjusted by fine tuning the node voltage V_{REF}. The value of the node voltage V_{REF} can be adjusted by the variable resistor R₁₅₀₅, and the reference voltages V_{REF1501} and V_{REF1502} can be defined according to the actual requirements of the panel.

In another aspect, the present invention further provides a panel display apparatus. As shown in FIG. 16, the panel display apparatus comprises a display panel 1601, a gate driving circuit 1602, and a driving apparatus 900. The gate driving circuit 1602 is electrically connected to the display panel 1601, and the driving apparatus 900 is electrically connected to the display panel 1601 through the output channels Ch1-Ch4. In the present embodiment, a panel display apparatus is achieved by the driving apparatus 900 of the embodiment of FIG. 10 according to the spirit of the present invention. The gate driving circuit 1602 is used to output at least a scan signal, so as to allow the driving apparatus 900 to provide at least a first driving voltage and a second driving voltage through the output channels Ch1-Ch4 in accordance with the scan signal. The first driving voltage and the second driving voltage are generated by first using the grayscale voltage generator 901 to generate multiple grayscale voltages with the same voltage polarity. Then, the digital-to-analog conversion unit 903 coupled to the grayscale voltage generator 901 determines whether or not to convert the grayscale voltages according to the received digital data, thereby providing the first driving voltage and the second driving voltage with opposite voltage polarities. Finally, the switch device 904 coupled to the digital-to-analog conversion unit 903 is used to switch the first driving voltage and the second driving voltage to the paths of the output channels Ch1-Ch4, wherein two adjacent output channels individually provide two voltages with different voltage polarities respectively (for example, the output channel Ch1 provides the first driving voltage, and the output channel Ch2 provides the second driving voltage). As for each of the output channels Ch1-Ch4, if a first driving voltage is provided in a frame period, a second driving voltage is provided in the next frame period. The above first driving voltage is a positive polarity voltage, and the second driving voltage is a negative polarity voltage. The detailed block diagram of the driving apparatus 900 and the relevant internal circuits are included in the embodiments of FIG. 11, FIG. 14, and FIG. 15.

To sum up, the output inverter is utilized as a main mechanism for inverting the voltage polarity in the present invention, such that the driving voltage output by the digital-to-analog conversion unit can be a positive polarity voltage or a negative polarity voltage. Thus, when the grayscale voltages supplied to the digital-to-analog conversion unit are reduced, the layout area of the driving apparatus of the display panel is effectively reduced, and the phenomena of the flicker and residual images of the display panel can also be reduced.

It will be apparent to those skilled in the art that various modifications and variations can be made to the structure of the present invention without departing from the scope or spirit of the invention. In view of the foregoing, it is intended that the present invention covers modifications and variations thereof provided they fall within the scope of the following claims.

What is claimed is:

1. A driving apparatus for use in a display panel, comprising:
a plurality of output channels for providing a first driving voltage and a second driving voltage;
a data latch unit for outputting multiple M-bit digital data, wherein M is a positive integer;
a grayscale voltage generator for generating 2^{M} grayscale voltages, wherein the voltage polarities of the grayscale voltages are the same;
a digital-to-analog conversion unit, coupled to the data latch unit and the grayscale voltage generator, comprising:
a first digital-to-analog converter coupled to the data latch unit and the grayscale voltage generator;
a second digital-to-analog converter coupled to the data latch unit and the grayscale voltage generator;
an output buffer, coupled to the first digital-to-analog converter, for outputting the first driving voltage; and
an output inverter, coupled to the second digital-to-analog converter, for outputting the second driving voltage;
a switch device, coupled to the digital-to-analog conversion unit, for switching the first driving voltage and the second driving voltage to the paths of the output channels, wherein if the output channel provides the first driving voltage in a frame period, the output channel provides the second driving voltage in the next frame period.

2. The driving apparatus of claim 1, wherein the switch device comprises:
a first switch having a first terminal coupled to the output buffer and a second terminal coupled to the output inverter, wherein in a first time period, the first terminal and a third terminal of the first switch are conducted, and in a second time period, the second terminal and the third terminal of the first switch are conducted; and
a second switch having a first terminal coupled to the output inverter and a second terminal coupled to the output buffer, wherein in the first time period, the first terminal and a third terminal of the second switch are conducted, and in the second time period, the second terminal and the third terminal of the second switch are conducted.

3. The driving apparatus of claim 1, wherein the output inverter comprises:
a first resistor;
a first amplifier having a first input terminal coupled to a second terminal of the first resistor, and a second input terminal of the first amplifier coupled to the ground;
a second resistor having a first terminal coupled to the first input terminal of the first amplifier, and a second terminal coupled to an output of the first amplifier; and
a second amplifier having a first input terminal electrically connected to an output of the second amplifier, and a second input terminal coupled to the output of the first amplifier.

4. The driving apparatus of claim 1, wherein the output inverter comprises:
a third resistor;
a third amplifier having a first input terminal coupled to a second terminal of the third resistor;
a fourth resistor having a first terminal coupled to the first input terminal of the third amplifier, and a second terminal coupled to an output of the third amplifier;
a fifth resistor having a second terminal coupled to a second input terminal of the third amplifier;
a variable resistor having a first terminal coupled to the second terminal of the fifth resistor;
a sixth resistor having a first terminal coupled to a second terminal of the variable resistor; and
a fourth amplifier having a first input terminal electrically connected to an output of the fourth amplifier, and a second input terminal coupled to the output of the third amplifier.

5. The driving apparatus of claim 1, wherein the voltage polarities of the first driving voltage and the second driving voltage are opposite.

6. The driving apparatus of claim 1, wherein the first driving voltage is a positive polarity voltage, and the second driving voltage is a negative polarity voltage.

7. The driving apparatus of claim 1, wherein the voltage polarities of the first driving voltage and the second driving voltage are determined depending on a common voltage.

8. The driving apparatus of claim 7, wherein the common voltage is a ground level.

9. The driving apparatus of claim 7, wherein the output buffer operates between the common voltage and a first voltage, and the output inverter operates between a second voltage and the common voltage.

10. The driving apparatus of claim 9, wherein the first voltage is a positive voltage, the second voltage is a negative voltage, and the absolute values of the first voltage and the second voltage are equal.

11. A digital-to-analog conversion unit, comprising:
2N digital-to-analog converters, wherein N is a positive integer;
N output buffers having the (i)^{th} output buffer coupled to the (2i−1)^{th} digital-to-analog converter, wherein i is an integer and 1≦i≦N, and each of the output buffers individually outputs a first driving voltage; and
N output inverters having the (i)^{th} output inverter coupled to the (2i)^{th} digital-to-analog converter, wherein each of the output inverters individually outputs a second driving voltage;
wherein the voltage polarities of the first driving voltage and the second driving voltage are opposite.

12. The digital-to-analog conversion unit as claimed in claim 11, wherein each of the output inverters comprises:
a first resistor;
a first amplifier having a first input terminal coupled to a second terminal of the first resistor, and a second input terminal coupled to the ground;
a second resistor having a first terminal coupled to the first input terminal of the first amplifier, and a second terminal coupled to an output of the first amplifier; and
a second amplifier having a first input terminal electrically connected to an output of the second amplifier, and a second input terminal coupled to the output of the first amplifier.

13. The digital-to-analog conversion unit as claimed in claim 11, wherein each of the output inverters comprises:
a third resistor;
a third amplifier having a first input terminal coupled to a second terminal of the third resistor;
a fourth resistor having a first terminal coupled to the first input terminal of the third amplifier, and a second terminal coupled to an output of the third amplifier;
a fifth resistor having a second terminal coupled to a second input terminal of the third amplifier;
a variable resistor having a first terminal coupled to the second terminal of the fifth resistor;
a sixth resistor having a first terminal coupled to a second terminal of the variable resistor; and
a fourth amplifier having a first input terminal electrically connected to an output of the fourth amplifier, and a second input terminal coupled to the output of the third amplifier.

14. The digital-to-analog conversion unit as claimed in claim 11, wherein the first driving voltage is a positive polarity voltage, and the second driving voltage is a negative polarity voltage.

15. The digital-to-analog conversion unit as claimed in claim 11, wherein the voltage polarities of the first driving voltage and the second driving voltage are determined depending on a common voltage.

16. The digital-to-analog conversion unit as claimed in claim 15, wherein the common voltage is a ground level.

17. The digital-to-analog conversion unit as claimed in claim 15, wherein the output buffers operate between the common voltage and a first voltage, and the output inverters operate between a second voltage and the common voltage.

18. The digital-to-analog conversion unit as claimed in claim 17, wherein the first voltage is a positive voltage, the second voltage is a negative voltage, and the absolute values of the first voltage and the second voltage are equal.

19. A panel display apparatus, comprising:
a display panel;
a gate driving circuit, electrically connected to the display panel, for outputting at least a scan signal; and
a driving apparatus, electrically connected to the display panel through multiple output channels, for providing at least a first driving voltage and a second driving voltage through the output channels in accordance with the scan signal, wherein the driving apparatus comprises:
a grayscale voltage generator for generating multiple grayscale voltages with the same voltage polarity; and
a digital-to-analog conversion unit, coupled to the grayscale voltage generator, for determining whether or not to inverse the grayscale voltages according to the digital data received by the digital-to-analog conversion unit, and further at least providing the first driving voltage and the second driving voltage, wherein the voltage polarities of the first driving voltage and the second driving voltage are opposite; and
a switch device, coupled to the digital-to-analog conversion unit, for switching the first driving voltage and the second driving voltage to the paths of the output channels, wherein, if the output channel provides the first driving voltage in a frame period, the output channel provides the second driving voltage in the next frame period.

20. The panel display apparatus as claimed in claim 19, wherein the digital-to-analog conversion unit comprises:
a first digital-to-analog converter electrically coupled to the grayscale voltage generator;
a second digital-to-analog converter electrically coupled to the grayscale voltage generator;
an output buffer, coupled to the first digital-to-analog converter, for outputting the first driving voltage; and
an output inverter, coupled to the second digital-to-analog converter, for outputting the second driving voltage.

21. The panel display apparatus as claimed in claim 20, wherein the switch device comprises:
a first switch, having a first terminal coupled to the output buffer, and a second terminal coupled to the output inverter, wherein, in a first time period, the first terminal and a third terminal of the first switch are conducted, and in a second time period, the second terminal and the third terminal of the first switch are conducted; and
a second switch having a first terminal coupled to the output inverter, and a second terminal coupled to the output buffer, wherein, in the first time period, the first terminal and a third terminal of the second switch are conducted, and in the second time period, the second terminal and the third terminal of the second switch are conducted.

22. The panel display apparatus as claimed in claim 19, wherein the first driving voltage is a positive polarity voltage, and the second driving voltage is a negative polarity voltage.

23. The panel display apparatus as claimed in claim 19, wherein the voltage polarities of the first driving voltage and the second driving voltage are determined depending on a common voltage.

24. The panel display apparatus as claimed in claim 23, wherein the common voltage is a ground level.
